(19) United States
(12) Patent Application Publication
(10) Pub. No.: US 2016/0106037 A1
(43) Pub. Date: Apr. 21, 2016

(54) HYDRAULIC HEADER CONTROL OF A COMBINE HARVESTER

(71) Applicant: AGCO Corporation, Hesston, KS (US)

(72) Inventors: Curtiss M. LEE, Garden Plain, KS (US); Ryan L. SWENSON, Wichita, KS (US); Allen C. LEE, Garden Plain, KS (US)

(21) Appl. No.: 14/516,110

(22) Filed: Oct. 16, 2014

(51) Int. Cl. A01D 41/127; A01D 47/00; A01D 41/06

(52) U.S. Cl. CPC A01D 41/127; A01D 41/06; A01D 47/00

(57) ABSTRACT

In one embodiment, a method of controlling a hydraulic header that is coupled to a feeder house of a combine harvester, the method comprising: providing, by a pump, a flow of hydraulic fluid through a first plurality of components fluidly coupled together, wherein in a first mode, the first plurality of components comprises a pump, a first-multi-position valve, a first port of a hydraulic cylinder, a second port of the hydraulic cylinder, a second-multi-position valve in a first position, and a well, wherein the hydraulic cylinder is affixed to the feeder house; providing, by the pump, a flow of hydraulic fluid through a second plurality of components fluidly coupled together, wherein in a second mode, the second plurality of components comprises the pump, the first-multi-position valve, the first port of the hydraulic cylinder, the second port of the hydraulic cylinder, the second-multi-position valve in a second position, and back to the first port of the hydraulic cylinder, bypassing the well and combining with the flow from a discharge of the pump; and switching between the first position and the second position to enable the switching between the first and second modes, wherein the header is raised by operation of the hydraulic cylinder according to the flow of the hydraulic fluid through the first plurality of components in the first mode and according to the flow of the hydraulic fluid through the second plurality of components in the second mode.

### TECHNICAL FIELD

The present disclosure is generally related to agricultural machines and, more particularly, combine harvesters.

### BACKGROUND

A variety of industries have machines with implements that rely on hydraulic power to raise and lower the headers. For instance, in front loader applications in the construction industry, hydraulic fluid may be provided to one or more hydraulic cylinders, which comprises a piston and rod assembly that moves under the influence of hydraulic fluid pressure, causing the implement to raise to lift loads of material (such as dirt or gravel) for deposit in other areas or in a truck bed, and to lower to return to a working position. Also, in front loader applications (or any loader applications), there are times when additional lift capacity is required for breaking or lifting a load, and times when a slower speed is needed for fine control. In another industry, such as the agricultural industry, a combine harvester may be equipped with one of a variety of types of detachable headers that likewise raises and lowers under the influence of hydraulic fluid pressure exerted through one or more hydraulic cylinders. In combine harvester applications, like loader applications, certain conditions require adaptability in controlling the hydraulic fluid flow to raise or lower the header. For instance, there are conditions that require the speed that the header is raised and lowered to be increased or decreased. One mechanism commonly used to enable such adaptability is through the use of a two-stage pump for the different conditions, the two-stage pumps enabling an increase in pressure or flow.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates, in front perspective view, an example machine in which an embodiment of an example hydraulic header control system may be implemented.

FIG. 2 is a schematic diagram that illustrates, in top fragmentary plan view, an embodiment of an example hydraulic header control system.

FIG. 3 is a schematic diagram that illustrates an embodiment of an example cylinder circuit coupled to ports of a hydraulic cylinder for a neutral configuration.

FIG. 4 is a schematic diagram that illustrates an embodiment of the example cylinder circuit and hydraulic cylinder of FIG. 3 with one of the multi-positional valves in a header-raise configuration and another multi-positional valve in a position to place an embodiment of an example hydraulic header control system in a power mode.

FIG. 5 is a schematic diagram that illustrates an embodiment of the example cylinder circuit and hydraulic cylinder of FIG. 4 with one of the multi-positional valves in the header-raise configuration and another multi-positional valve in a position to place an embodiment of an example hydraulic header control system in a speed mode.

FIG. 6A is a block diagram of an embodiment of an example control circuit for an embodiment of a hydraulic header control system.

FIG. 6B is a block diagram of an embodiment of an example controller used in the example control circuit of FIG. 6A.

FIG. 7 is a flow diagram that illustrates an embodiment of an example hydraulic header control method.

### DESCRIPTION OF EXAMPLE EMBODIMENTS

### Overview

In one embodiment, a method of controlling a hydraulic header that is coupled to a feeder house of a combine harvester, the method comprising: providing, by a pump, a flow of hydraulic fluid through a first plurality of components fluidly coupled together, wherein in a first mode, the first plurality of components comprises a pump, a first-multi-position valve, a first port of a hydraulic cylinder, a second port of the hydraulic cylinder, a second-multi-position valve in a first position, and a well, wherein the hydraulic cylinder is affixed to the feeder house; providing, by the pump, a flow of hydraulic fluid through a second plurality of components fluidly coupled together, wherein in a second mode, the second plurality of components comprises the pump, the first-multi-position valve, the first port of the hydraulic cylinder, the second port of the hydraulic cylinder, the second-multi-position valve in a second position, and back to the first port of the hydraulic cylinder, bypassing the well and combining with the flow from a discharge of the pump; and switching between the first position and the second position to enable the switching between the first and second modes, wherein the header is raised by operation of the hydraulic cylinder according to the flow of the hydraulic fluid through the first plurality of components in the first mode and according to the flow of the hydraulic fluid through the second plurality of components in the second mode.

### Detailed Description

Certain embodiments of a hydraulic header control system and method are disclosed that enable a raising of a header according to one of two available modes of operation (e.g., a speed mode and a power mode) without the use of implementation of multi-speed pumps. In one embodiment, the hydraulic header control system comprises one or more hydraulic cylinders that are affixed to a feeder house (and the chassis), the feeder house in turn coupled to the header in known manner. Hydraulic fluid, under the influence of a hydraulic pump, flows through one or more cylinder circuits, each comprising valves arranged in a regenerative configuration, enabling selective (e.g., automatic or user-invoked) operation between a power mode when more power is needed to raise the header and a speed mode when more speed is needed to raise the header.

By contrast, in some conventional combine headers, the requirement for increased pressure or flow is achieved through the use of two-stage pumps. With certain embodiments of a hydraulic header control system, costs may be reduced in terms of energy and/or product costs, while using low maintenance, regenerative valve systems to selectively cause operation in multiple modes that meet varied conditions in the field.

Having summarized certain features of a hydraulic header control system of the present disclosure, reference will now be made in detail to the description of the disclosure as illustrated in the drawings. While the disclosure will be described in connection with these drawings, there is no intent to limit it to the embodiment or embodiments disclosed herein. For instance, though emphasis is placed on a machine in the agricultural industry, and in particular, a combine harvester, certain embodiments of a hydraulic header control system may be beneficially deployed in other machines (in the same or other industries) where an implement is utilized to perform the intended application of the machine. Also, attention is focused below on raising of the header, though it should be appreciated that lowering of the header is also contemplated and readily ascertainable from the figures and corresponding description below. Further, although the description identifies or describes specifics of one or more embodiments, such specifics are not necessarily part of every embodiment, nor are all of any various stated advantages necessarily associated with a single embodiment. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine harvester looking forwardly.

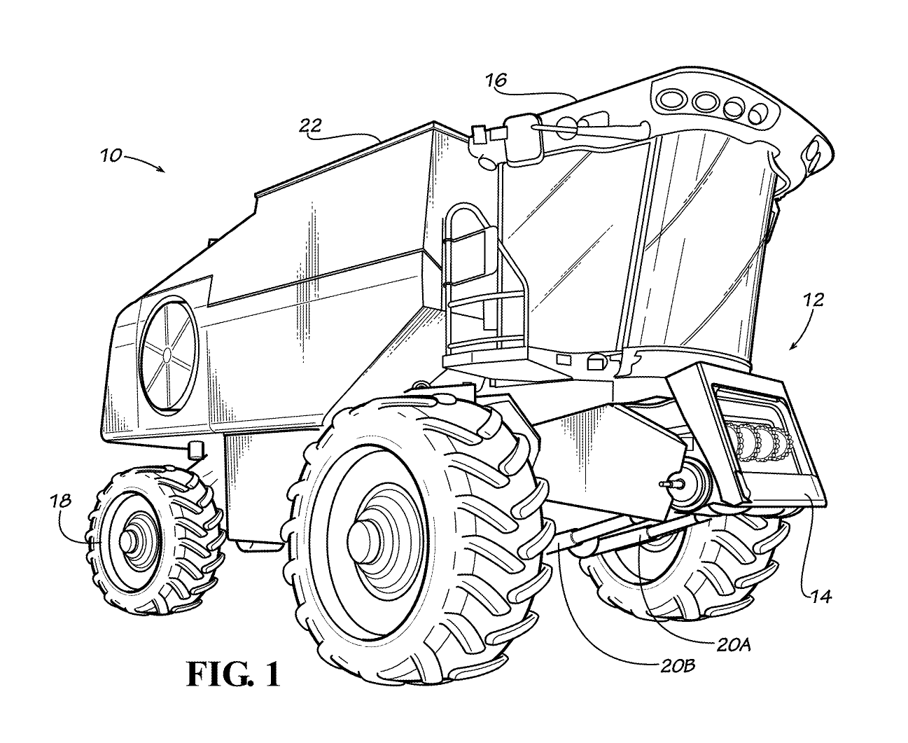

Reference is made to FIG. 1, which illustrates an example agricultural machine embodied as an example combine harvester 10, which utilizes an embodiment of a hydraulic header control system 12. One having ordinary skill in the art should appreciate in the context of the present disclosure that the example combine harvester 10 is merely illustrative, and that other machines and/or implements with like functionality may deploy certain embodiments of a hydraulic header control system 12. The example combine harvester 10 is shown in FIG. 1 without a header, and from front to back, comprises a feeder house 14 and an operator cab 16 that is mounted to a chassis supported by wheels 18. In some embodiments, other or additional forms of travel may be used, such as tracks. Also shown are plural hydraulic cylinders 20 (e.g., 20A and 20B) that are affixed, in one embodiment, to the underside of the feeder house 14 on one end and to the chassis on the other end in known manner. As is known, the feeder house 14 moves (e.g., up and down, tilt, etc.) based on actuation of the hydraulic cylinders 20, which causes a detachably coupled header to also be raised, lowered, and/or tilted.

In general the combine harvester 10 cuts crop materials (e.g., using the header), wherein the cut crop materials are delivered to the front end of the feeder house 14. Such crop materials are moved upwardly and rearwardly within and beyond the feeder house 14 (e.g., by a conveyer) until reaching a processor comprising a thresher rotor. In one embodiment, the thresher rotor may comprise a single, transverse rotor, such as that found in a Gleaner® Super Series Combine by AGCO. Other designs may be used, such as axial-based, twin rotor, or hybrid designs. The thresher rotor processes the crop materials in known manner and passes a portion of the crop material (e.g., heavier chaff, corn stalks, etc.) toward the rear of the combine harvester 10 and another portion (e.g., grain and possibly light chaff) through a cleaning process in known manner. In the processor, the crop materials undergo threshing and separating operations. In other words, the crop materials are threshed and separated by the thresher rotor operating in cooperation with well-known foraminous processing members in the form of threshing concave assemblies and separator grate assemblies, with the grain (and possibly light chaff) escaping through the concave assemblies and the grate assemblies and to a cleaning system located beneath the processor to facilitate the cleaning of the heavier crop material. Bulkier stalk and leaf materials are generally retained by the concave assemblies and the grate assemblies and are discharged out from the processor and ultimately out of the rear of the combine harvester 10. The cleaned grain that drops to the bottom of the cleaning system is delivered by a conveying mechanism that transports the grain to a well-known elevator mechanism (not shown), which conveys the grain to a grain bin 22 located at the top of the combine harvester 10. Any remaining chaff and partially or unthreshed grain is recirculated through the processor via a tailings return conveying mechanism. As combine processing is known to those having ordinary skill in the art, further discussion of the same is omitted here for brevity.

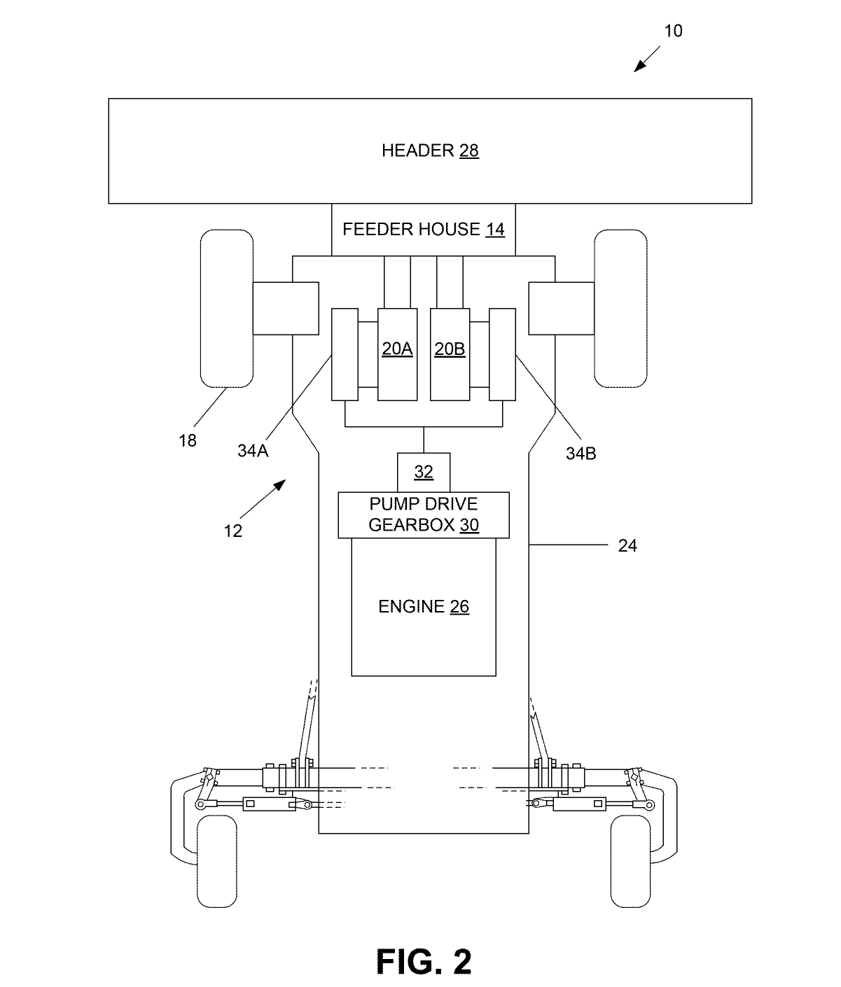

FIG. 2 is a schematic diagram that illustrates, in top fragmentary plan view, an embodiment of an example hydraulic header control system 12 of the combine harvester 10. It should be appreciated by one having ordinary skill in the art in the context of the present disclosure that the hydraulic header control system 12 depicted in FIG. 2 is merely illustrative, and that some embodiments may use additional or fewer components in a different arrangement to achieve a similar function. The combine harvester 10 may include a chassis or frame 24 supported by the wheels 18 for movement across a field. The chassis 24 supports a rearwardly spaced compartment housing an internal combustion engine 26. The chassis 24 also supports a ground drive system that, in one embodiment, when powered by the engine 26, causes rotation (e.g., differential rotation) of the wheels 18 as is known in the art. The combine harvester 10 also comprises a coupled working implement, schematically depicted in FIG. 2 as a harvesting header 28, which is coupled to the feeder house 14 in a manner known and understood by those skilled in the art. The header 28 may be configured as a modular unit and consequently may be disconnected for removal from the feeder house 14.

Continuing, the engine 26 is coupled to a pump drive gearbox 30, which in turn is coupled to a hydraulic pump 32. The pump drive gearbox 30 uses the power of the engine 26 to drive the hydraulic pump 32. In one embodiment, the pump 32 provides for pressurized, hydraulic fluid flow to plural hydraulic cylinders 20A, 20B via respective cylinder circuits 34A, 34B. The pump 32, cylinder circuit 34A, and hydraulic cylinder 20A are coupled to each other via a fluidic medium, such as tubing, hoses, etc. Likewise, the pump 32, cylinder circuit 34B, and hydraulic cylinder 20B are coupled to each other via a fluidic medium. In one embodiment, the cylinder circuit 34A and hydraulic cylinder 20A are arranged in parallel with the cylinder circuit 34B and hydraulic cylinder 20B. In some embodiments, a single hydraulic cylinder 20 (e.g., 20A or 20B) and associated cylinder circuit 34 (e.g., 34A or 34B) may be used. In some embodiments, multiple hydraulic pumps may be used, one for each respective cylinder circuit 34 and hydraulic cylinder 20. In some embodiments, a single cylinder circuit 34 (e.g., 34A or 34B) may be used with two hydraulic cylinders 20 (e.g., 20A and 20B), wherein the hydraulic cylinders 20 are arranged in parallel. In operation, the power of the engine 26 is transferred to the hydraulic pump 32 via the pump drive gearbox 30. The pump 32 provides pressurized hydraulic fluid flow to the hydraulic cylinder 20 via the respective cylinder circuits 34, which in turn control whether the established fluid flow circuit is arranged to achieve a speed mode or a power mode. The hydraulic cylinder 20 actuates in response to the fluid flow, causing a raising (and lowering) of the header 28 based on the selected mode of operation.

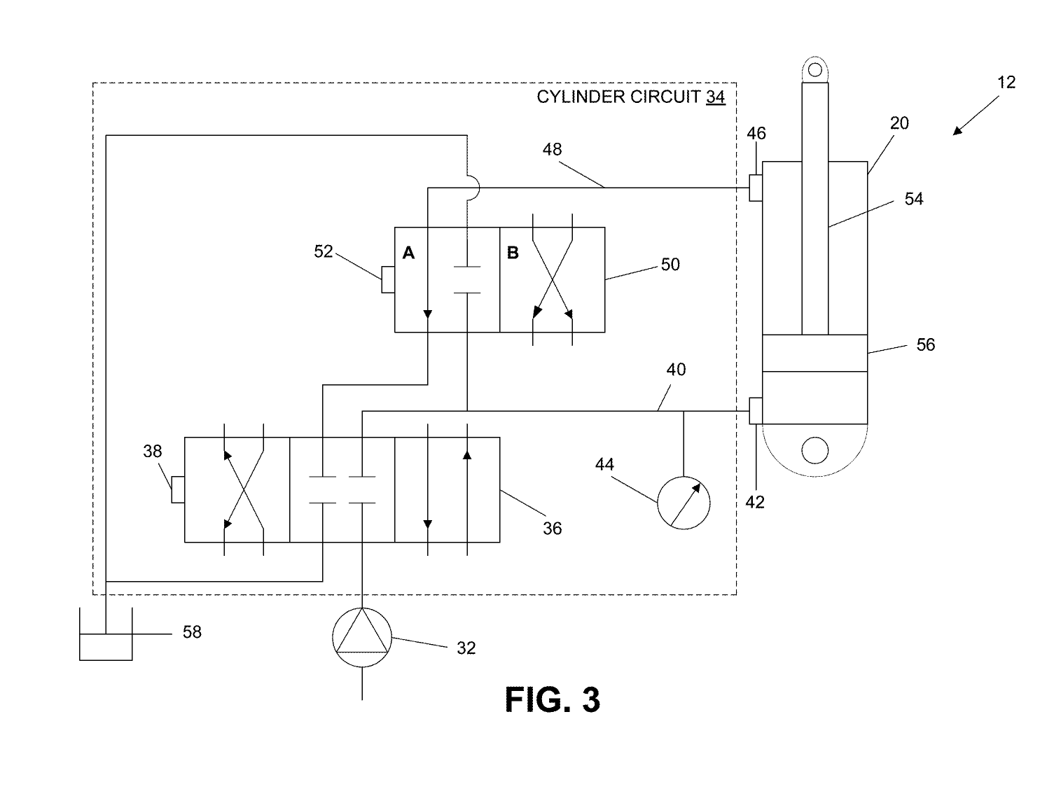

Having generally described an example arrangement and operation of an embodiment of a hydraulic header control system 12, attention is directed to FIG. 3, which illustrates an embodiment of an example cylinder circuit 34 of the hydraulic header control system 12. As depicted in FIG. 3, the cylinder circuit 34 is coupled to multiple (e.g., two) ports of a hydraulic cylinder 20 and includes a multi-positional valve positioned in a neutral configuration. It should be appreciated by one having ordinary skill in the art, in the context of the present disclosure, that the example hydraulic header control system 12 depicted in FIG. 3 is merely illustrative, and that in some embodiments, additional, fewer, and/or different components to achieve similar functionality may be used. Although shown using a single hydraulic cylinder 20, the description below is easily and readily applied to the use of multiple cylinders using an additional cylinder circuit 34 and hydraulic cylinder 20 coupled to the outlet (e.g., discharge) of the pump 32, or in some embodiments, a single cylinder circuit 34, and multiple hydraulic cylinders 20 that are arranged in parallel. As shown, the hydraulic header control system 12 comprises the hydraulic cylinder 20 coupled (e.g., fluidly coupled) to the cylinder circuit 34. The cylinder circuit 34 receives pressurized fluid flow from the discharge of the pump 32, and controls the manner of fluid flow into and out of the hydraulic cylinder 20 based on a regenerative valve system of the cylinder circuit 34. The cylinder circuit 34 comprises a first multi-positional valve 36 coupled to the discharge of the pump 32. In one embodiment, the first multi-positional valve 36 comprises a three-position valve, though not limited to a three-position valve in some embodiments. The first multi-positional valve 36 comprises an actuator 38 (e.g., electrical, such as a solenoid, or in some embodiments, pneumatic or other forms of control). The actuator 38 receives signals from a controller or other device (e.g., sensor or relay) to cause a change in position of the multi-positional valve 36.

As depicted in FIG. 3, the first multi-positional valve 36 is positioned in a neutral position, wherein in one embodiment, there is no hydraulic fluid flow through the cylinder circuit 34. The first multi-positional valve 36 is coupled to a supply side fluid medium 40 (e.g., tubing, hose, etc.), which provides a fluid medium between the first multi-positional valve 36 and an inlet port 42 of the hydraulic cylinder 20. In some embodiments, a sensor 44 (e.g., pressure sensor, flow sensor, etc.) is coupled to the supply side fluid medium 40 to enable sensing of a fluid operational parameter (e.g., flow, pressure, etc.) for the hydraulic fluid flowing into the inlet port 42 of the hydraulic cylinder 20. The hydraulic cylinder 20 also comprises an outlet port 46, which enables fluid to be output from the hydraulic cylinder 20 to a fluid medium 48. The fluid medium 48 (e.g., tubing, hoses, etc.) fluidly couples the hydraulic cylinder 20 to a second multi-positional valve 50. The second multi-positional valve 50 comprises an actuator 52 (e.g., of the same or similar construction as the actuator 38) that, upon signaling from a controller or other device, changes a position of the second multi-positional valve 50. In one embodiment, the second multi-positional valve 50 comprises a two-position valve, with the positions depicted in FIG. 3 as position A and position B. Referring again to the hydraulic cylinder 20, in one embodiment, the hydraulic cylinder 20 comprises a rod 54 and piston 56 assembly of known construction. As is known, based on differences in area (and hence pressure) across the rod 54 and piston 56 assembly, the rod 54 and piston 56 assembly move (e.g., extending the rod 54 past the housing of the hydraulic cylinder 20, or retracting the rod 54 to at least partially within the housing of the hydraulic cylinder 20). The rod 54 couples at the depicted open-end to the feeder house 14 (FIG. 1) and the piston-end bracket couples to the chassis 24 of the combine harvester 10 in known manner. Also shown is a well or reservoir 58 to receive the hydraulic fluid in some configurations.

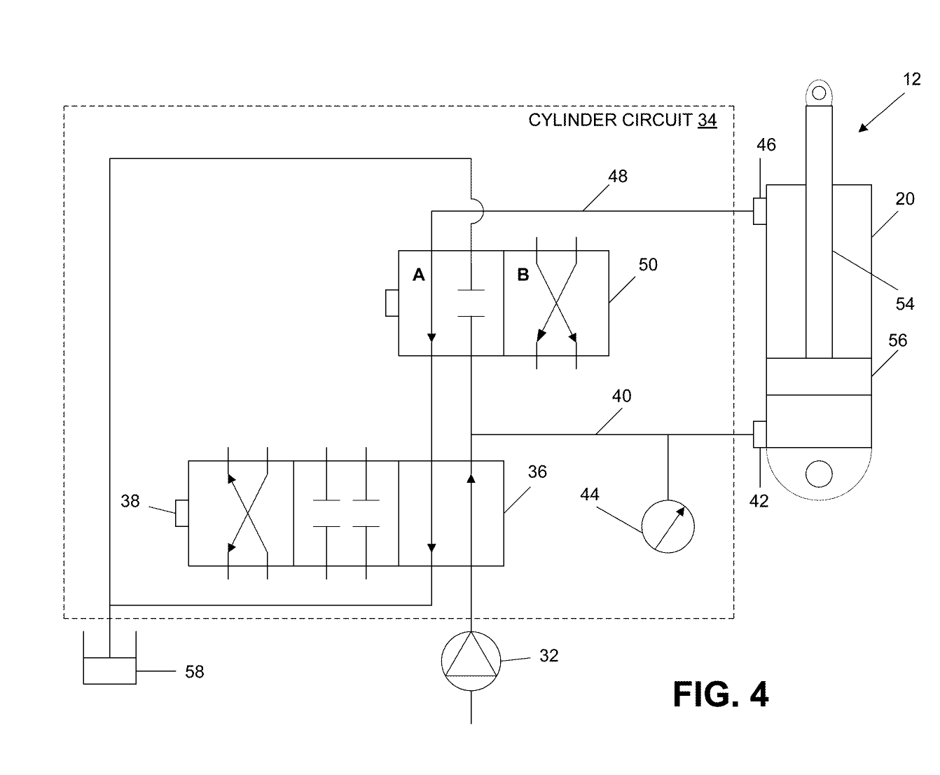

Referring now to FIG. 4, shown is a schematic diagram that illustrates an embodiment of the example cylinder circuit 34 and the hydraulic cylinder 20 of the hydraulic header control system 12 as similarly shown in FIG. 3, with the first multi-positional valve 36 configured in a header-raise configuration and the second multi-positional valve 50 configured to place the hydraulic header control system 12 in a power mode. For instance, the second multi-positional valve 50 is positioned as in FIG. 3 (the “A” position), and now with the first multi-positional valve 36 actuated (e.g., via a signal received at the actuator 38) to change the configuration of the first multi-positional valve 36 from the neutral position (FIG. 3) to the header-raise configuration of FIG. 4, hydraulic fluid flow is enabled to cause the actuation of the hydraulic cylinder 20 via the cylinder circuit 34. Fluid flow is conveyed as follows. The pump 32 discharges hydraulic fluid through the first multi-positional valve 36 and to the inlet port 42 of the hydraulic cylinder 20 via the fluid medium 40. The pressure differential created across the rod 54 and piston 56 assembly causes the rod 54 and piston 56 assembly to extend the rod 54 further beyond the housing of hydraulic cylinder 20 to cause a raising of the feeder house 14 and coupled header 28 (FIG. 2). Through this action, hydraulic fluid is discharged from the outlet port 46 through fluid medium 48, through the second multi-positional valve 50, and to the well 58. The aforementioned fluid flow and associated components establish a fluidic circuit that enables the hydraulic header control system 12 to operate in a power mode. For instance, a heavier load may be handled by a flip of a switch by the operator (or automatically implemented, based on an operational parameter sensed by the sensor 44, such as fluid pressure, exceeding a trigger or threshold).

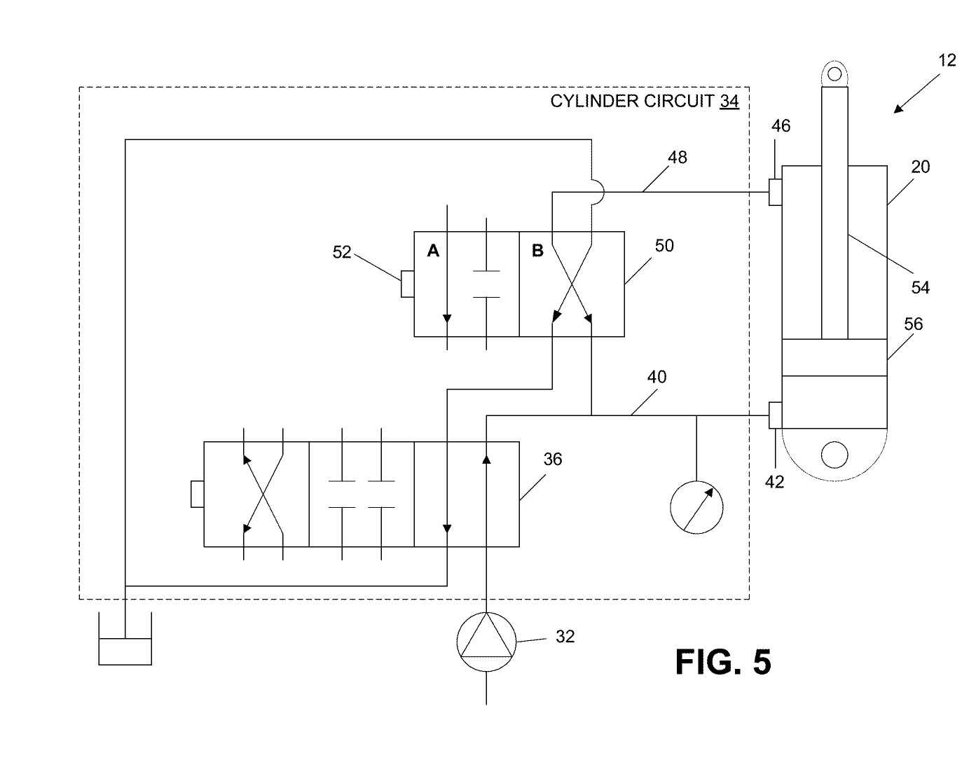

Referring to FIG. 5, shown is a schematic diagram that illustrates an embodiment of the example cylinder circuit 34 and hydraulic cylinder 20 of FIG. 4 with the first multi-positional valve 36 configured in the header-raise configuration and the second multi-positional valve 50 configured (e.g., as actuated by actuator 52) in a position (position “B”) to place the hydraulic header control system 12 in a speed mode. In the speed mode, the fluid discharged from outlet port 46 of the hydraulic cylinder 20 is connected (via the second multi-positional valve 50) to the inlet port 42 of the hydraulic cylinder 20 in regenerative manner. In other words the hydraulic fluid output from the second multi-positional valve 50 and the hydraulic fluid output from the first multi-positional valve 36 join in the fluid medium 40, enabling an increase in the hydraulic fluid flow into the inlet port 42 and increasing the speed of the rod 54 and piston 56 assembly movement, causing a concomitant increase in header-raise speed via the coupled feeder house 14 (FIG. 2) and header 28 (FIG. 2). The fluidic circuit established by this configuration includes the flow from the pump 32 and through the first multi-positional valve 36 to the inlet port 42 of the hydraulic cylinder 20, actuating the rod 54 and piston 56 assembly. The hydraulic fluid is forced out of the outlet port 46, through the second multi-positional valve 50 (the “B” position) via the fluid medium 48, and back to join the hydraulic fluid flow at the inlet port 42.

It should be appreciated that variations in the cylinder circuit 34 in relation to the other components of the hydraulic header control system 12 may be implemented in some embodiments to achieve a similar effect. For instance, the hydraulic fluid may be joined prior to the location shown, such as joining with the hydraulic fluid at the outlet of the pump 32 before the inlet to the first multi-positional valve 36.

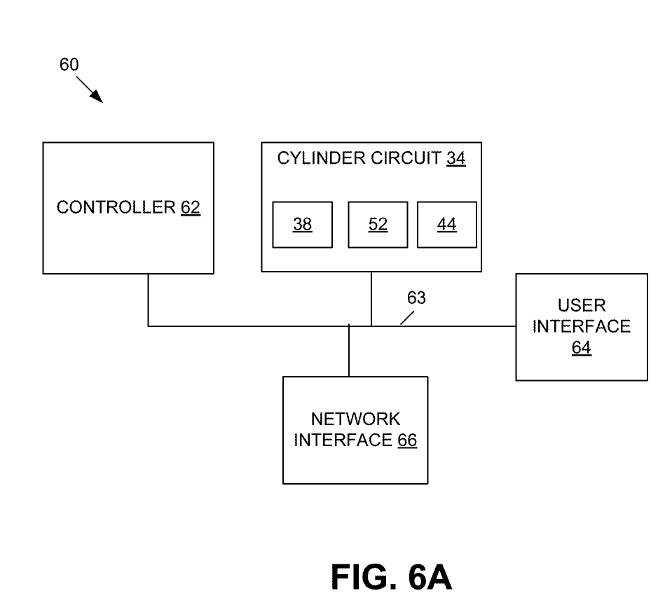

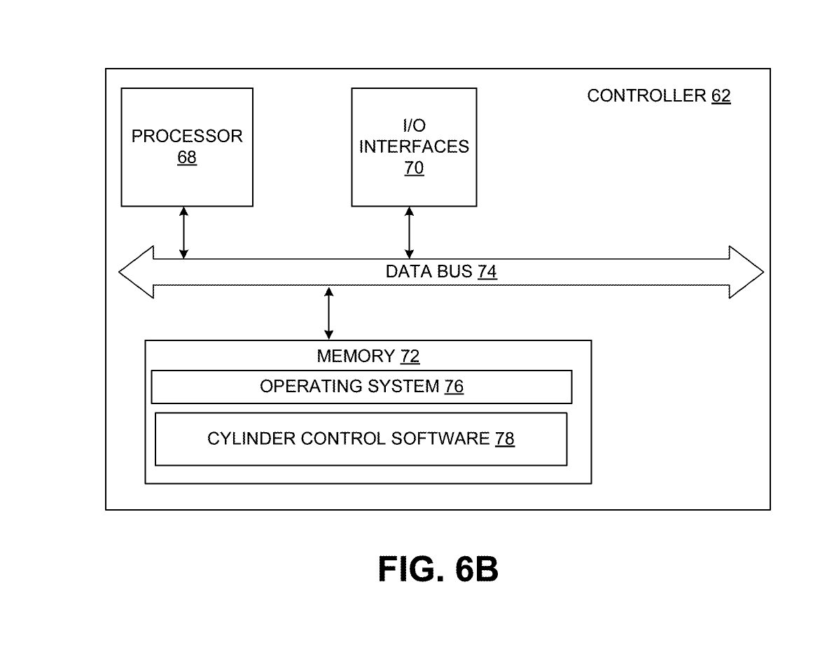

Attention is now directed to FIG. 6A, which illustrates an embodiment of an example control circuit 60 of the hydraulic header control system 12. It should be appreciated within the context of the present disclosure that some embodiments may include additional components or fewer or different components, and that the example depicted in FIG. 6A is merely illustrative of one embodiment among others. The control circuit 60 comprises one or more controllers, such as the controller 62. The controller 62 is coupled via one or more networks, such as network 63 (e.g., a CAN network or other network, such as a network in conformance to the ISO 11783 standard, also referred to as “Isobus”), to one or more cylinder circuits 34, a user interface 64, and a network interface 66. Note that in some embodiments, the control circuit 60 may use a controller dedicated to the cylinder circuits 34, in which signals from the main controller 62 are relayed to the dedicated controller via the network 63. In some embodiments, each controller of the control circuit 60 may operate in a peer-to-peer configuration. These and/or other variations in the architecture may be implemented, and hence are contemplated to be within the scope of the disclosure.

The user interface 64 may include one or more of a keyboard, mouse, microphone, touch-type display device, joystick, steering wheel, FNR lever, or other devices (e.g., switches, immersive head set, etc.) that enable input and/or output by an operator (e.g., to respond to indications presented on the screen or aurally presented, or in some embodiments, to enable input by the operator based on observation of the field conditions) and/or enable monitoring of machine operations.

The network interface 66 comprises hardware and/or software that enable wireless connection to one or more remotely located computing devices over a network (e.g., wireless or mixed wireless and wired networks). For instance, the network interface 66 may cooperate with browser software and/or other software of the controller 62 to communicate with a server device over cellular links, among other telephony communication mechanisms and radio frequency communications, enabling remote monitoring or control of the combine harvester 10 (FIG. 1) and/or its associated functions. The network interface 66 may comprise MAC and PHY components (e.g., radio circuitry, including transceivers, antennas, etc.), as should be appreciated by one having ordinary skill in the art.

In one embodiment, the controller 62 is configured to receive and process information from the cylinder circuit 34 (e.g., the sensor 44), and communicate a signal or signals to the cylinder circuit 34 (e.g., the actuators 38 and 52) to cause the hydraulic header control system 12 to selectively, and automatically, operate in a power mode or a speed mode. In some embodiments, the selective operation between the power and speed modes may be achieved with operator intervention, such as based on a parameter presented on the user interface 64 showing or alerting the operator to the event of the parameter reaching or exceeding (or falling below) a predetermined or threshold operational parameter (e.g., pressure exceeding a defined threshold). For instance, upon being alerted of such an event, the operator may switch modes by selecting a button or switch (or screen icon) or providing a verbal command. In some embodiments, the sensor 44 may not be used (or may not be available) in the process of switching modes, such as where the operator observes conditions in the field and switches the mode based on those observations.

Note that in some embodiments, a more rudimentary control mechanism may be used. For instance, through a purely hardware configuration (e.g., using the sensor 44, a relay or contact, and the cylinder circuit 34), an embodiment of the hydraulic header control system 12 may achieve transitions between modes. In one embodiment, a sensor 44 may be used to open or close a contact or relay circuit based on an operational parameter value of the hydraulic fluid in the cylinder circuit reaching or exceeding (or falling below) a predetermined value, which enables automatic signaling of the actuators 38 and/or 52 and actuation of the respective multi-positional valves 36 and/or 50.

FIG. 6B further illustrates an example embodiment of the controller 62 shown in FIG. 6A. One having ordinary skill in the art should appreciate in the context of the present disclosure that the example controller 62 is merely illustrative, and that some embodiments of controllers may comprise fewer or additional components, and/or some of the functionality associated with the various components depicted in FIG. 6B may be combined, or further distributed among additional modules, in some embodiments. It should be appreciated that, though described in the context of residing in the combine harvester 10 (FIG. 1), in some embodiments, the controller 62, or all or a portion of its corresponding functionality, may be implemented in a computing device or system located external to the combine harvester 10. Referring to FIG. 6B, with continued reference to FIG. 6A, the controller 62 is depicted in this example as a computer system, but may be embodied as a programmable logic controller (PLC), field programmable gate array (FPGA), application specific integrated circuit (ASIC), among other devices. It should be appreciated that certain well-known components of computer systems are omitted here to avoid obfuscating relevant features of the controller 62. In one embodiment, the controller 62 comprises one or more processors, such as processor 68, input/output (I/O) interface(s) 70, and memory 72, all coupled to one or more data busses, such as data bus 74. The memory 72 may include any one or a combination of volatile memory elements (e.g., random-access memory RAM, such as DRAM, and SRAM, etc.) and nonvolatile memory elements (e.g., ROM, hard drive, tape, CDROM, etc.). The memory 72 may store a native operating system, one or more native applications, emulation systems, or emulated applications for any of a variety of operating systems and/or emulated hardware platforms, emulated operating systems, etc. In some embodiments, a separate storage device may be coupled to the data bus 74, such as a persistent memory (e.g., optical, magnetic, and/or semiconductor memory and associated drives).

In the embodiment depicted in FIG. 6B, the memory 72 comprises an operating system 76 and cylinder control software 78. The cylinder control software 78 receives user input and/or sensor input, and responds with one or more signals (sent wirelessly or over a wired medium, such as the network 63) to the actuators 38 and/or 52 of the cylinder circuit 34 to achieve operation of a hydraulic cylinder(s) 20 and cylinder circuit(s) 34 according to two selectable modes (fast and power). Execution of the cylinder control software 78 may be implemented by the processor 68 under the management and/or control of the operating system 76. In some embodiments, the operating system 76 may be omitted and a more rudimentary manner of control implemented. The processor 68 may be embodied as a custom-made or commercially available processor, a central processing unit (CPU) or an auxiliary processor among several processors, a semiconductor based microprocessor (in the form of a microchip), a macroprocessor, one or more application specific integrated circuits (ASICs), a plurality of suitably configured digital logic gates, and/or other well-known electrical configurations comprising discrete elements both individually and in various combinations to coordinate the overall operation of the controller 62.

The I/O interfaces 70 provide one or more interfaces to the network 63 and other networks. In other words, the I/O interfaces 70 may comprise any number of interfaces for the input and output of signals (e.g., analog or digital data) for conveyance of information (e.g., data) over the network 63. The input may comprise input by an operator (local or remote) through the user interface 64, and/or input from signals carrying information from one or more of the components of the combine harvester 10, such as the sensors 44, an associated controller, and/or the network interface 66, among other devices. Outputs may be provided to the cylinder circuit 34 via the network 63.

When certain embodiments of the controller 62 are implemented at least in part with software (including firmware), as depicted in FIG. 6B, it should be noted that the software (e.g., such as the cylinder control software 78) can be stored on a variety of non-transitory computer-readable medium for use by, or in connection with, a variety of computer-related systems or methods. In the context of this document, a computer-readable medium may comprise an electronic, magnetic, optical, or other physical device or apparatus that may contain or store a computer program (e.g., executable code or instructions) for use by or in connection with a computer-related system or method. The software may be embedded in a variety of computer-readable mediums for use by, or in connection with, an instruction execution system, apparatus, or device, such as a computer-based system, processor-containing system, or other system that can fetch the instructions from the instruction execution system, apparatus, or device and execute the instructions.

When certain embodiments of the controller 62 are implemented at least in part with hardware, such functionality may be implemented with any or a combination of the following technologies, which are all well-known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), relays, contactors, etc.

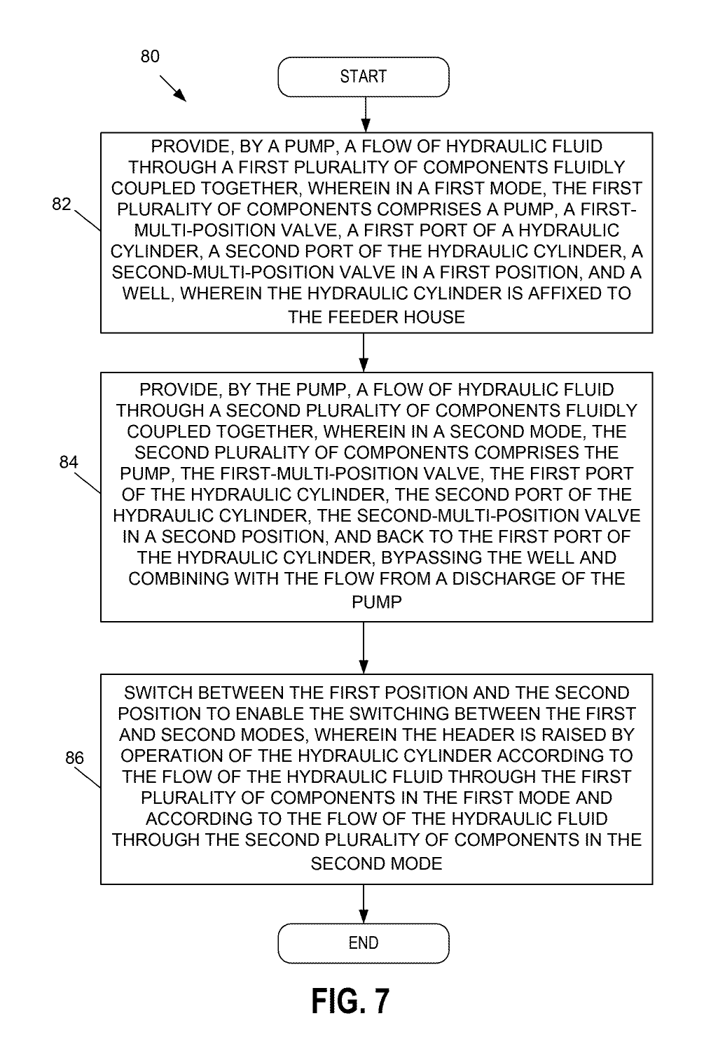

In view of the above description, it should be appreciated that one embodiment of a method 80 of controlling a hydraulic header that is coupled to a feeder house of a combine harvester, as depicted in FIG. 7, comprises: providing, by a pump, a flow of hydraulic fluid through a first plurality of components fluidly coupled together, wherein in a first mode, the first plurality of components comprises a pump, a first-multi-position valve, a first port of a hydraulic cylinder, a second port of the hydraulic cylinder, a second-multi-position valve in a first position, and a well, wherein the hydraulic cylinder is affixed to the feeder house (82); providing, by the pump, a flow of hydraulic fluid through a second plurality of components fluidly coupled together, wherein in a second mode, the second plurality of components comprises the pump, the first-multi-position valve, the first port of the hydraulic cylinder, the second port of the hydraulic cylinder, the second-multi-position valve in a second position, and back to the first port of the hydraulic cylinder, bypassing the well and combining with the flow from a discharge of the pump (84); and switching between the first position and the second position to enable the switching between the first and second modes, wherein the header is raised by operation of the hydraulic cylinder according to the flow of the hydraulic fluid through the first plurality of components in the first mode and according to the flow of the hydraulic fluid through the second plurality of components in the second mode (86).

Any process descriptions or blocks in flow diagrams should be understood as representing steps in the process, and alternate implementations are included within the scope of the embodiments in which functions may be executed out of order from that shown or discussed, as would be understood by those reasonably skilled in the art of the present disclosure.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein. Although the control systems and methods have been described with reference to the example embodiments illustrated in the attached drawing figures, it is noted that equivalents may be employed and substitutions made herein without departing from the scope of the disclosure as protected by the following claims.

At least the following is claimed:

1. A combine harvester, comprising:
a chassis;
a feeder house mounted to the chassis;
a header mounted to the feeder house; and
a control system, comprising:
a pump;
a well;
a hydraulic cylinder comprising a first port, a second port, and a piston and rod assembly that is bi-directionally moveable between the first and second ports, the hydraulic cylinder affixed to the feeder house and arranged to cause a raising and lowering of the feeder house and the header; and
a cylinder circuit coupled to the first and second ports and switchably configurable between a first mode and a second mode of header raising operations, the cylinder circuit comprising:
a first multi-position valve coupled between an outlet of the pump and the first port; and
a second multi-position valve coupled to the second port,
wherein in the first mode, a first fluidic circuit is established in series between the pump, the multi-position valve in a first position, the first port, the second port, the second multi-position valve in a first position, and the well,
wherein in the second mode, a second fluidic circuit is established in series between the pump, the multi-position valve in the first position, the first port, the second port, the second multi-position valve in a second position, and the first port.

2. The combine harvester of claim 1, wherein based on hydraulic fluid flow in the second fluidic circuit, the hydraulic cylinder causes the header to raise at a faster speed in the second mode than in the first mode.

3. The combine harvester of claim 1, wherein based on hydraulic fluid flow in the first fluidic circuit, the hydraulic cylinder causes the header to raise with higher force in the first mode than in the second mode.

4. The combine harvester of claim 1, further comprising a control circuit comprising:
a controller coupled to the cylinder circuit; and
a sensor coupled to the controller and configured to sense an operational parameter of the cylinder circuit, wherein the controller is automatically configured to cause a switching of the cylinder circuit between the first and second modes based on the operational parameter sensed by the sensor.

5. The combine harvester of claim 4, wherein the operational parameter comprises pressure at the first port.

6. The combine harvester of claim 4, wherein the second multi-position valve comprises an actuator, wherein the controller is automatically configured to cause the switching of the cylinder circuit by sending a signal to the actuator of the second multi-position valve.

7. The combine harvester of claim 1, further comprising a control circuit comprising:
a controller coupled to the cylinder circuit; and
a first user interface, wherein the controller is configured to cause a switching of the cylinder circuit between the first and second modes based on operator input received at the first user interface.

8. The combine harvester of claim 7, further comprising a second user interface and a sensor coupled to the controller, wherein the second user interface is configured to present an operational parameter sensed by the sensor prompting the receiving of the operator input.

9. The combine harvester of claim 8, wherein the second user interface is configured to present the operational parameter visually, audibly, or a combination of visually and audibly.

10. The combine harvester of claim 7, wherein the second multi-position valve comprises an actuator, wherein the controller is configured to cause the switching of the cylinder circuit by sending a signal to the actuator of the second multi-position valve.

11. The combine harvester of claim 1, wherein the control system comprises another multi-port hydraulic cylinder coupled affixed to the feeder house and coupled to the cylinder circuit to enable a raising and lowering of the feeder house and the header.

12. A method of controlling a hydraulic header that is coupled to a feeder house of a combine harvester, the method comprising:
providing, by a pump, a flow of hydraulic fluid through a first plurality of components fluidly coupled together, wherein in a first mode, the first plurality of components comprises a pump, a first-multi-position valve, a first port of a hydraulic cylinder, a second port of the hydraulic cylinder, a second-multi-position valve in a first position, and a well, wherein the hydraulic cylinder is affixed to the feeder house;
providing, by the pump, a flow of hydraulic fluid through a second plurality of components fluidly coupled together, wherein in a second mode, the second plurality of components comprises the pump, the first-multi-position valve, the first port of the hydraulic cylinder, the second port of the hydraulic cylinder, the second-multi-position valve in a second position, and back to the first port of the hydraulic cylinder, bypassing the well and combining with the flow from a discharge of the pump; and
switching between the first position and the second position to enable the switching between the first and second modes, wherein the header is raised by operation of the hydraulic cylinder according to the flow of the hydraulic fluid through the first plurality of components in the first mode and according to the flow of the hydraulic fluid through the second plurality of components in the second mode.

13. The method of claim 12, wherein the switching occurs automatically.

14. The method of claim 13, further comprising sensing an operational parameter corresponding to the hydraulic fluid flows, wherein the switching occurs responsive to a change in the sensed operational parameter.

15. The method of claim 12, the switching occurs with operator intervention.

16. The method of claim 12, wherein based on the flow of the hydraulic fluid through the second plurality of components in the second mode, the hydraulic cylinder causes the header to raise at a faster speed in the second mode than in the first mode.

17. The method of claim 12, wherein based on the flow of the hydraulic fluid through the first plurality of components in the first mode, the hydraulic cylinder causes the header to raise with higher force in the first mode than in the second mode.

18. The method of claim 12, further comprising a second hydraulic cylinder having plural ports and coupled to the hydraulic cylinder in a parallel configuration to receive the hydraulic fluid flows.

19. A system, comprising:
a combine harvester comprising a feeder house coupled to a header, and plural hydraulic cylinders affixed to the feeder house to operably raise and lower the header; and
a control circuit comprising a pump and regenerative valve system coupled to the plural hydraulic cylinders, wherein the regenerative valve system is configured to selectively pass hydraulic fluid flow from a respective discharge port of the plural hydraulic cylinders to a respective inlet port of the plural hydraulic cylinders to raise the header in a speed mode, wherein the regenerative valve system is further configured to selectively pass hydraulic fluid flow from the respective discharge port of the plural hydraulic cylinders to a well of the control circuit to raise the header in a power mode.

20. The system of claim 19, further comprising a controller configured to cause operation in either the first mode or the second mode, the controller configured to cause the operation based on one of operator input or automatically.
